(19) United States
(12) Patent Application Publication
(10) Pub. No.: US 2009/0108968 A1
(43) Pub. Date: Apr. 30, 2009

(54) MAGNETIC DEVICE COMBINED WITH A VELCRO TAPE

(76) Inventors: Chang-Heng Tsai, Jhongli City (TW); Li-Zhu Chen, Jhongli City (TW)

Correspondence Address: ANTHONY R. BARKUME, 20 GATEWAY LANE, MANORVILLE, NY, 11949, US

(21) Appl. No.: 12/254,168

(22) Filed: Oct. 20, 2008

(30) Foreign Application Priority Data
Oct. 25, 2007 (TW) 096218100

(51) Int. Cl. H01F 7/02

(52) U.S. Cl. 335/219

(57) ABSTRACT

A magnetic device combined with a Velcro tape comprises: a magnet body having a surface equipped a groove; a Velcro tape placing in the groove for functioned with magnetic and hooking force from both the magnet body and the Velcro tape. The Velcro tape can also directly connect on the surface of the magnet body.

### FIELD OF THE INVENTION

The present invention relates to a magnetic device combined with a Velcro tape, especially the magnetic device with a Velcro tape on the surface.

### BACKGROUND OF THE INVENTION

It means a customarily used stuff—affixing way made by glues, magnets and a Velcro tape. Although the customary affixing way with glues can make anything affixed to any locations, yet the unavailability for repeated usage is exactly the most critical defect. Once glues are used, it is unavailable for repeated usage. However, the customarily used magnets or a Velcro tape are merited with the availability for repeated usage. The customarily used magnet can be used to arrest iron, cobalt and other magnetized stuffs. Thus, it has been widely applied to daily life. For example, the magnet designed with particular figures is oftentimes used as the magnetic tags affixed to refrigerators at home. The customarily used Velcro tape can be divided into a male part and a female part. Both female and male parts can be closely affixed together. If required, the affixture can be set apart; thereafter, it is also available for affixture again with quite convenient operation available.

Although the customarily used a Velcro tape or magnets are designed with simple usage, the device is also flawed with some defects. The customarily used magnet can be used to arrest iron stuffs only. Not all stuffs to be affixed is made of iron, thus, it is not quite convenient as people supposed. Despite no limitation to affixing locations for a Velcro tape, any location with iron stuffs to be affixed must previously affix the male part for female part to iron stuffs and then it is just available for affixture made by another part.

The prior techniques are flawed with below defects:
1. once customary affixture with glues is well adhered to stuffs, it is no more available for repeated usage;
2. customarily used magnets can be used to arrest iron and magnetized stuffs only, despite the availabilities for repeated usage; it is still flawed with the inconvenience for usage;
3. customarily used magnets can be used to arrest iron and magnetized stuffs only, despite the availabilities for repeated usage; it is still flawed with the inconvenience for usage.

Thus, how to improve aforesaid defects but integrate the advantages from both iron and a Velcro tape is the main topic for the present invention.

### SUMMARY OF THE INVENTION

An objective of the present invention is to provide a newly designed and advanced device combined with both magnets and a Velcro tape together. A groove is placed on the magnet surface with a male or female part inserted in the groove; the magnetic device is not only functioned with magnetic but also the affixing force of a Velcro tape.

According to the invention, a magnetic device combined with a Velcro tape comprises: a magnet body having a surface equipped a groove; and a Velcro tape placing in the groove for functioned with magnetic and hooking force from both the magnet body and the Velcro tape.

In accordance with one aspect of the present invention, the groove is formed by hollowing a hole in the magnet body and further adding with a bottom layer in the hole.

In accordance with one aspect of the present invention, the magnet body is of a soft stuff.

In accordance with one aspect of the present invention, the Velcro tap is male or female, and the groove is centrally placed on the surface.

According to another aspect of the present invention, a magnetic device combined with a Velcro tape, comprising: a magnet body having a surface; a Velcro tape placing on the surface functioned with magnetic and hooking force from both the magnet body and the Velcro tape.

The present invention may best be understood through the following description with reference to the accompanying drawings, in which:

### BRIEF DESCRIPTION OF THE DRAWINGS

FIG. 1 shows the magnetic device combined with a Velcro tape according to the present invention;

FIG. 2 shows the cross-section of the magnetic device assembled with a Velcro tape according to the present invention;

FIG. 3 shows the cross-section of the magnetic device attached with Velcro tape according to the present invention; and

FIG. 4 shows the cross-section of the magnetic device with a bottom layer according to the present invention.

### DETAILED DESCRIPTION OF THE INVENTION

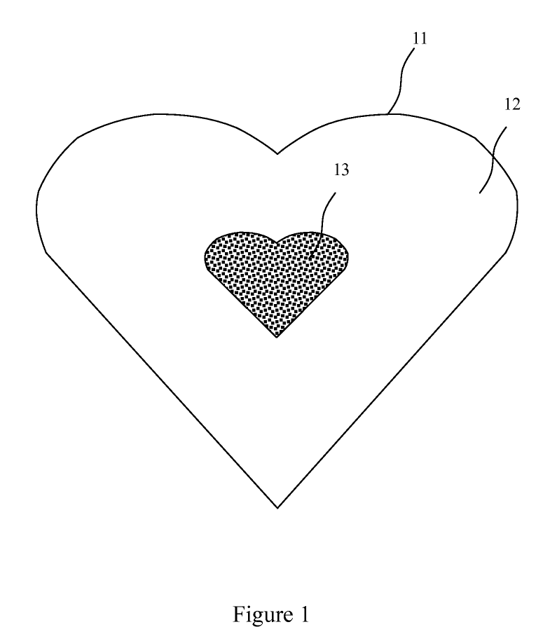

FIG. 1 shows the illustration with the advanced intentional function with both a Velcro tape and magnets wherein the device includes a magnet body 11, a surface 12 and a Velcro tape 13.

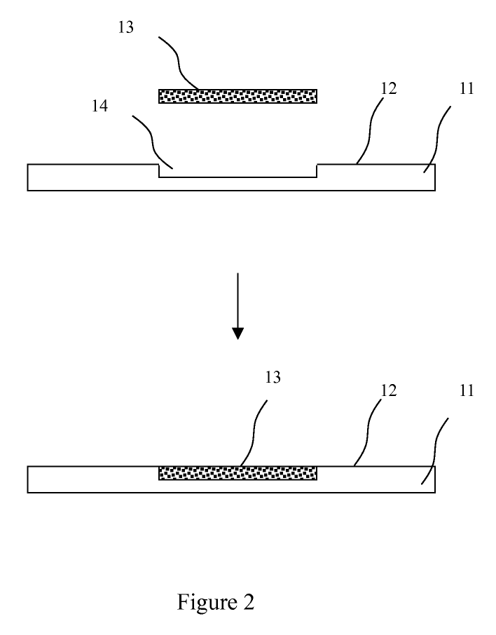

FIG. 2 shows the cross-section illustration with the advanced intentional function with both a Velcro tape and magnets wherein the device includes a magnet body 11, a surface 12, a Velcro tape and a groove 14. The Velcro tape 13 can be affixed to the groove 14 in any available way.

According to the present invention, there is a groove 14 on the surface 12 of a magnet body 11, wherein a Velcro tape is equipped in the groove 14. It is available to affix the region of the magnetic part outside the groove 12 on the magnetic materials. The Velcro tape 12 in the groove can be also affixed any location. It is typically for users' best convenience at will. Both affixture options available for a Velcro tape or magnets can be well exerted with the function double assured.

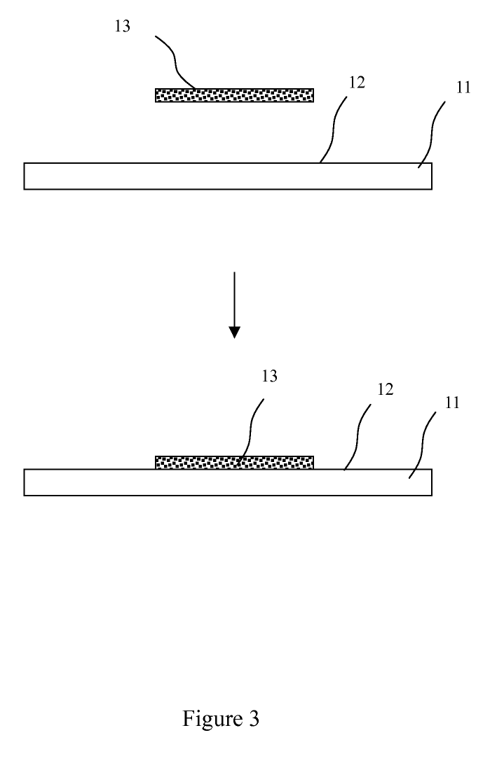

FIG. 3 shows another cross-section illustration of a magnet combined with a Velcro tape, advanced functions from both a Velcro tape and magnets wherein the device includes a magnet body 11, a surface 12 and a Velcro tape 13. The Velcro tape 13 can be affixed to the surface 12 of the magnet body 11 in any available way. Such a design can meet users' any demand available for affixture options from both magnets and a Velcro tape at will; thus the function can be double assured.

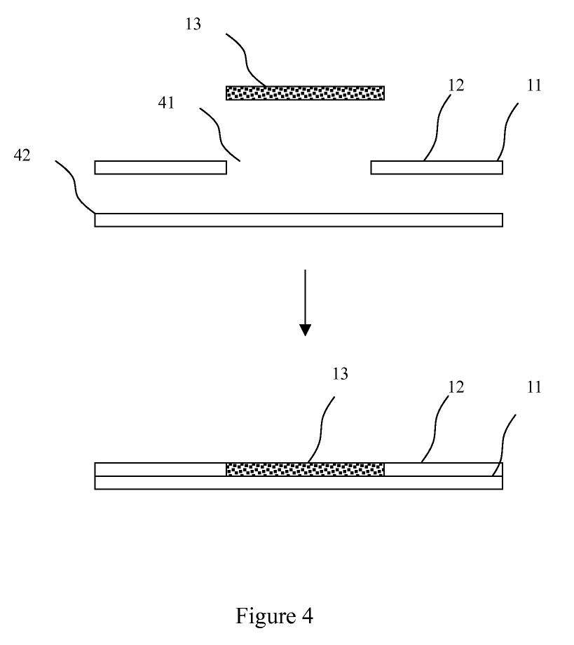

FIG. 4 shows the exploded/cross-section view illustration of a hallowed magnets added with a bottom layer in a magnet combined with a Velcro tape, advanced functions from both a Velcro tape and magnets wherein the device includes a magnet body 11, a surface 12, a Velcro tape 13, a hole 41 and a bottom layer 42. The formation of a groove illustrated in FIG. 2 can form a hole 41 in a magnet body and then a bottom layer 42 is further combined. This bottom layer can be available any material like magnet, plastic, paper or any stuffs. The combination can be reached by any possible means of pressing, affixing and gluing.

The magnetic device combined with a Velcro tape proposed in the present invention wherein the magnet can be a soft stuff. The Velcro tape equipped in a groove can be a male or female part. The location of a groove can be placed on the central location or any given one otherwise. The sizes and shapes of groove can be randomly changed with various patent applications. The reverse magnet side to the Velcro tape can be designed with any appealing artwork figures for marketable demands. The Velcro tape 13 in the groove can be also affixed any location.

The present invention is merited with the advantages as below:

1. The magnet combined with a Velcro tape proposed in the present invention can be merited with the advantages from both magnets and a Velcro tape with the function double assured.

2. As per the magnet combined with Velcro tape in the present invention, both the magnet and the Velcro tape can be repeatedly affixing or hooking. It is merited with repeated usage available.

3. As per the magnet combined with Velcro tape in the present invention, it can freely meet users' demands with both available options from a Velcro tape or magnet affixtures and the convenience is enhanced.

To sum up aforesaid mention, as per the magnet combined with a Velcro tape, there is a groove placed on the magnet surface and a Velcro tape is also inserted in the groove. It is not only functioned with convenient magnet affixture but also with easy hooking of a Velcro tape. It is newly designed with excellent practicability such as various changes in design, various shapes and sizes of grooves, various types of magnets or various locations designed for a groove. As long as the magnet surface is equipped with a Velcro tape, all of them should be disclosed and covered by the present invention.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims to be accorded with the broadest interpretation so as to encompass all such modifications and similar solutions.

What is claimed is:

1. A magnetic device combined with a Velcro tape, comprising:
a magnet body having a surface equipped a groove;
a Velcro tape placing in the groove for functioned with magnetic and hooking force from both the magnet body and the Velcro tape.

2. The magnetic device according to claim 1, wherein the groove is formed by hollowing a hole in the magnet body and further adding with a bottom layer in the hole.

3. The magnetic device according to claim 1, wherein the magnet body is of a soft stuff.

4. The magnetic device according to claim 1, wherein the Velcro tap is male.

5. The magnetic device according to claim 1, wherein the Velcro tap is female.

6. The magnetic device according to claim 1, wherein the groove is centrally placed on the surface.

7. A magnetic device combined with a Velcro tape, comprising:
a magnet body having a surface;
a Velcro tape placing on the surface functioned with magnetic and hooking force from both the magnet body and the Velcro tape.

8. The magnetic device according to claim 7, wherein the magnet body is of a soft stuff.

9. The magnetic device according to claim 7, wherein the Velcro tap is male.

10. The magnetic device according to claim 7, wherein the Velcro tap is female.
